(19) United States
(12) Patent Application Publication
(10) Pub. No.: US 2008/0080635 A1
(43) Pub. Date: Apr. 3, 2008

(54) Advanced feedback signaling for multi-antenna transmission systems

(75) Inventors: Klaus Hugl, Helsinki (FI); Olav Tirkkonen, Helsinki (FI)

Correspondence Address: BANNER & WITCOFF, LTD., 1100 13th STREET, N.W., SUITE 1200, WASHINGTON, DC, 20005-4051, US

(73) Assignee: Nokia Corporation, Espoo (FI)

(21) Appl. No.: 11/605,402

(22) Filed: Nov. 29, 2006

(30) Foreign Application Priority Data
Oct. 2, 2006 (EP) 06020735.4

(51) Int. Cl. H04L 1/02

(52) U.S. Cl. 375/267

(57) ABSTRACT

The present invention relates to enhanced feedback in a multi-antenna transmission system, wherein an operation mode of a multi-antenna transmission end may be determined at a reception end of a connection, and a feedback information and a mode indicator may be generated based on the determined operation mode and transmitted to the multi-antenna transmission end where the feedback information may be interpreted based on the mode indicator.

### RELATED APPLICATION INFORMATION

This application claims priority to European provisional application EP06020735.4, filed Oct. 2, 2006, whose contents are expressly incorporated herein by reference.

### FIELD OF THE INVENTION

The present invention relates to providing feedback signaling in a multi-antenna transmission system, such as multiple-input multiple-output (MIMO) system.

### BACKGROUND

Rising importance of wireless services has led to corresponding increased demand for higher network capacity and performance. Conventional options include higher bandwidth, optimized modulation or code-multiplex systems, but offer practically only limited potential to increase the spectral efficiency.

In so-called MIMO (Multiple Input Multiple Output) systems antenna arrays are used to enhance bandwidth efficiency. MIMO systems provide multiple inputs and multiple outputs for a single channel and are thus able to exploit spatial diversity and spatial multiplexing. Further information about MIMO systems can be gathered from the IEEE specifications 802.11n, 802.16-2004 and 802.16e, as well as 802.20 and 802.22 which relate to other standards. Specifically, MIMO systems have been introduced to radio systems like e.g. WiMAX (Worldwide Interoperability for Microwave Access) and are currently standardized in 3GPP for WCDMA (Wideband Code Division Multiple Access) as well as 3GPP E-UTRAN (Enhanced Universal Mobile Telecommunications System (UMTS) Terrestrial Radio Access Network), such as LTE (Long Term Evolution) or 3.9G.

In case of MIMO systems, multi-stream transmission increases the possible peak-data rate and as a consequence also the achievable system capacity. Currently in 3GPP, there is single user MIMO (SU-MIMO) as well as MU-MIMO (multi-user MIMO) discussed for the downlink (DL) shared data channel of 3GPP LTE systems.

SU-MIMO denotes transmission to a single user on a resource block with either single stream or multi-stream transmission. The adaptation between single stream transmission and multi-stream transmission depends on the available rank of the mobile radio channel as well as the operation point in respect to SINR (signal-to-interference-plus-noise ratio).

MU-MIMO denotes transmission to several users on a single resource block in DL by precoded transmission from a base station device (BS, referred to as “Node B” in 3GPP terminology) to several users. It is of advantage, if the transmission to several users in the same resource is done with mutual orthogonal transmission weights and/or precoding. It is noted that the number of users which can transmit at the same time within a single resource block by Space Division Multiple Access (SDMA) is limited by the number of available transmission (Tx) antennas at the Node B.

Different MIMO transmission modes in downlink require different information in order to allow appropriate link adaptation. A mobile station (MS, also referred to us “user equipment” (UE) in 3D terminology) may have a linear or non-linear reception unit and Mr reception antennas, while the node B has Mt transmission antennas. Based on partial or full channel state information (CSI) fed back from the MS, the BS may perform appropriate space-time processing such as multiuser scheduling, power and modulation adaptation, beamforming, and space-time coding. The CSI may include a channel direction information (CDI) and a channel quality information (CQI), which can be used for determining beamforming direction and power allocation.

According to the transmitter structure of per-antenna rate control (PARC) systems, separately encoded data streams are transmitted from each antenna with equal power but possibly with different data rates The data rates for each antenna are controlled by adaptively allocating transmission resources such as modulation order, code rate, and in case of CDMA systems the number of spreading codes. The post-decoding SINR or any other measure indicating the supported data rate of each transmission antenna is estimated at the receiver and then fed back to the transmitter, which is used to determine the data rate on each antenna. The CQI feedback may be transmitted directly as a quantization in the SINR domain, or it may be mapped to a supportable transport format before transmission. A vector signaling with more feedback overhead over conventional scalar signaling is thus required for link adaptation. E.g. in case of PARC for 2 Tx antennas, a CQI for both streams is fed back to the BS regardless of whether the transmission with two streams makes sense at all, e.g., due to channel correlation or SNR (signal-to-noise ratio) operation point make. Similar issues are also valid for CSI or precoding information.

In case of SU-MIMO with two transmission antennas and multi-codeword transmission, two streams (i.e., spatial multiplexing rate 2) with independent modulation and coding are provided, so that the CQI information of both streams is needed in order to allow link adaptation, whereas in case of a single stream fall-back mode (e.g. single stream beamforming) just a single CQI information is needed for adaptive modulation and coding (AMC).

Thus, different MIMO transmission modes in downlink require different information in order to allow appropriate processing, such as link adaptation. However, traditional CQI or CSI feedback schemes are independent of the selected MIMO transmission scheme. Accordingly, there is a need for an advanced feedback transmission scheme.

### SUMMARY

In light of the foregoing, the present invention relates to methods and systems for advanced and flexible feedback signaling in multi-antenna transmission systems.

In a certain exemplary embodiment, a method includes the steps of determining at a reception end of a connection a preferred operation mode of a multi-antenna transmission end of said connection, generating feedback information and a mode indicator based on said determined preferred operation mode, and forwarding said feedback information together with said mode indicator in a data stream transmitted from said reception end via said connection to said multi-antenna transmission end.

In another example, a method includes the steps of receiving at a multi-antenna transmission end a data stream which comprises a feedback information, extracting from said received data stream said feedback information and a mode indicator which indicates an operation mode of said multi-antenna transmission end, and interpreting said feedback information based on said mode indicator in order to control multi-antenna transmission.

In yet another example, a receiver electronic apparatus may include a processor controlling at least some operations of the receiver apparatus and a memory storing computer executable instructions that, when executed by the processor, cause the receiver apparatus to perform a method of multi-antenna transmission, the method comprising determining an operation mode of a multi-antenna transmission end, generating feedback information and a mode indicator based on said determined operation mode, and forwarding said feedback information together with said mode indicator in a data stream transmitted from said receiver apparatus to said multi-antenna transmission end.

In another example, a transmitter electronic apparatus may include may include a processor controlling at least some operations of the transmitter apparatus and a memory storing computer executable instructions that, when executed by the processor, cause the transmitter apparatus to perform a method of multi-antenna transmission, the method comprising receiving a data stream which comprises a feedback information, extracting from said received data stream said feedback information and a mode indicator which indicates an operation mode of a selected multi-antenna transmission scheme, and interpreting said feedback information based on said mode indicator in order to control multi-antenna transmission in response to said feedback information.

According to another aspect, systems may include one or more transmitter apparatus similar to the one described above, and one or more receiver apparatus similar to the one described above.

According to another aspect, computer program products may include code for producing the steps of methods similar to those described above when run on a computing device.

Accordingly, certain embodiments relate to a simple and effective feedback scheme, which is based on a mode indicator for indicating different kinds of feedback information in the same signaling setup in order to facilitate scheduling, link adaptation or any other processing that may be required for multi-antenna transmission. Thereby, different operation modes can be supported by the same amount of total feedback information, possibly without requiring any change in the signaling setup. Of course, this advantage may apply to multiple different kinds of feedback schemes where the feedback information is dependent on the operating mode of involved transmission beams.

The additional amount of feedback related to the spatial domain might thus be kept small in addition to conventional single-stream feedback. Feedback bit-fields can be made dependent on the operation mode and therefore used to signal different kinds of information. This enables small amount of feedback compared to fixed reporting structures. Such a feedback structure might be utilized for different kinds of operation modes.

As an example, the determination of the operation mode may be performed based on a signaling received from the multi-antenna transmission end. This signaling may for example be a signaling of a protocol layer higher than the protocol layer of the data stream. Of course, various other ways or means of determining the operation mode could be implemented. It might for example be set by the network operator or the user to influence operation of the transmission end.

In a specific example, the operation mode may be selected from one of a single-stream transmission mode, a single-user transmission mode, a multi-user transmission mode, a diversity transmission mode, or an open loop single-user transmission mode.

In addition to mode identification or signaling, the mode indicator may for example be used to indicate additional information specifying the operation mode.

In an exemplary embodiment, the feedback information may indicate at least one of a channel quality information, a channel state information and a preceding information. Of course, other information may be indicated or signaled by the feedback information depending on the concerned kind of multi-antenna transmission system. The mode indicator may also be used to define an allocation and interpretation of individual bits of this feedback information.

According to certain implementation examples, a one-bit mode indicator or a two-bit mode indicator may be used in a system where the multi-antenna transmission end comprises two transmission antennas. As an alternative, a two-bit mode indicator or three-bit mode indicator may be used in a system where the multi-antenna transmission end comprises four transmission antennas. Of course, even mode indicators with higher bit numbers can be used, for example, if the available number of operation modes demands a higher number of values

According to another aspect, the control of multi-antenna transmission may include at least one of scheduling, preceding, beamforming, multiplexing and link adaptation.

### BRIEF DESCRIPTION OF THE DRAWINGS

Other objects and features will become apparent from the following detailed description considered in conjunction with the accompanying drawings. It is to be understood, however, that the drawings are designed solely for purposes of illustration and not as a definition of the limits of the invention, for which reference should be made to the appended claims only. It should be further understood that the drawings are merely intended to conceptually illustrate the structures and procedures described herein.

FIG. 1 shows a schematic diagram of a multi-antenna transmission system according to certain aspects of the invention;

FIG. 2 shows a schematic block diagram of a mobile transceiver unit according to certain aspects of the invention;

FIG. 3 shows a schematic block diagram of a base station device according to certain aspects of the invention;

FIG. 4 shows a flow diagram of a feedback generation method according to certain aspects of the invention;

FIG. 5 shows a flow diagram of a feedback processing method according to certain aspects of the invention;

FIG. 6 shows a schematic block diagram of a computer-based implementation according to certain aspects of the invention; and

FIGS. 7A to 7F show various interpretation examples of feedback information for different operation modes, according to certain aspects of the invention.

### DETAILED DESCRIPTION OF EMBODIMENTS

In the following description of the various embodiments, reference is made to the accompanying drawings, which form a part hereof, and in which is shown by way of illustration various embodiments in which the invention may be practiced. It is to be understood that other embodiments may be utilized and structural and functional modifications may be made without departing from the scope and spirit of the present invention.

The embodiment will now be described in relation to a wireless multi-antenna transmission system, such as, but not limited to, a MIMO system with a general UL feedback scheme for MIMO DL transmission, including different multi-antenna operating modes, e.g., SU-MIMO as well as MU-MIMO, for an exemplary case of two available Tx antennas at a transmitter unit of a base station device, such as a Node B. However, it will be apparent from the following description and is therefore explicitly stressed that these embodiments can be applied to other network architectures with different radio access technologies involving multi-antenna transmitter devices (e.g. base station devices, access points or other access devices) capable of being operated in different operating modes.

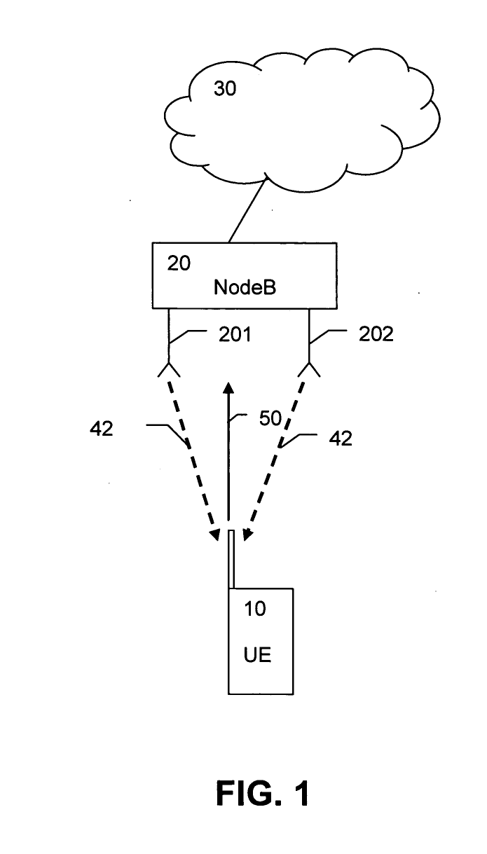

FIG. 1 shows an illustrative multi-antenna system in which a mobile station (MS) 10 (or UE in 3G terminology) is radio-connected to a base station device (BS) 20 (or Node B in 3G terminology) which comprises two Tx antennas 201 and 202 for transmitting respective DL radio transmission 42 towards the MS 10. The MS 10 may transmit an UL transmission 50 towards the base station device 20, which may provide access to a radio access network 30, such as an E-UTRAN or the like. The UL signal may be received at the BS 20 by the same antennas 201 or 202 or an additional reception antenna may alternatively be provided. The MS 10 might alternatively have more than a single antenna available that could be used for dual-antenna or multi-antenna transmission in UL direction and/or SU-MIMO reception of DL radio transmissions 42.

In a certain implementation example, an SU-MIMO operation mode with the two Tx antennas 201 and 202 and a multi-codeword transmission mode are considered. Of course, other operation modes may be provided as well. In case that two transmission streams (i.e., spatial multiplexing rate “2”) with independent modulation and coding (multi-codeword MIMO—such as “PARC”) are used, a CQI information might be required for both streams in order to allow link adaptation, whereas in case of a single stream fall-back mode (e.g. single stream beamforming) only a single CQI information for AMC may be needed.

According to certain embodiments, an advanced feedback scheme may be based on a mode indicator for signaling the transmission scheme or method and which may allow transmission of different kinds of CQI and CSI or precoding information in the same signaling setup to the BS 20 in order to facilitate scheduling and link adaptation. Such embodiments may therefore change the interpretation of the feedback information based on the MIMO operation mode, and transmit a mode indicator, which may be needed at the BS 20 in order to correctly interpret the provided feedback information received from the MS 10.

In the present example, the basic MIMO operation mode (e.g., SU-MIMO or MU-MIMO) may be defined semi-statically (e.g., on a longer term scale) by the BS 20, e.g. by using a higher layer signaling. As an alternative or in addition thereto, the basic operation mode may be set by the network operator and/or by the user, or may be derived from any other network signaling. Depending on this basis or initial operation mode, the MS 10 may feed back different kind of MIMO related feedback information (e.g., information related to SU-MIMO or multi-user MIMO).

In the following examples, different possible kinds of feedback information which may be required for different transmission modes are described. In case of SU-MIMO with two transmit antennas, there is the possibility to have single stream transmission as well as two stream transmission. For single stream transmission, the CQI for the stream as well as some precoding and/or beamforming information may be required. If the CQI feedback information requires five bits (same as in SISO), three bits can be provided for precoding information (which allows a precoding codebook of size 23=8). Therefore, in such an example, the feedback information for a user in a channel/system situation that only supports single stream transmission may require a total of eight bits for combined CSI and CQI, wherein three of the eight bits are multi-antenna transmission specific.

In an example using SU-MIMO with two-stream transmission, some CQI information from two/both streams may be required. However, the full CQI information for each stream need not be transmitted. Rather, some relative CQI for the second stream with respect to the first stream may be sufficient. This relative CQI may have a length of three bit. The relative CQI has the effect, that only a certain difference in applicable AMC may be allowed between the streams. For multi-codeword MIMO with two streams and two Tx antennas, the precoding may have only a limited effect on the achievable throughput. Therefore, this feedback information could be left out. Thus, for multi-stream transmission SU-MIMO, the absolute CQI might be needed for the first stream (as in case of SISO) as well as three bits for the relative CQI for the second stream. In this example, the three bits for the relative CQI may be multi-antenna transmission specific.

In order to tell the BS 20 how the spatial feedback information should be interpreted, a mode indicator, which may in the present example consist of a single bit (but is not limited to this single bit), may show if spatial multiplexing or beamforming is signalled. In case of more Tx antennas or more operation modes, a multi-bit mode indicator can be used to differentiate more operating modes.

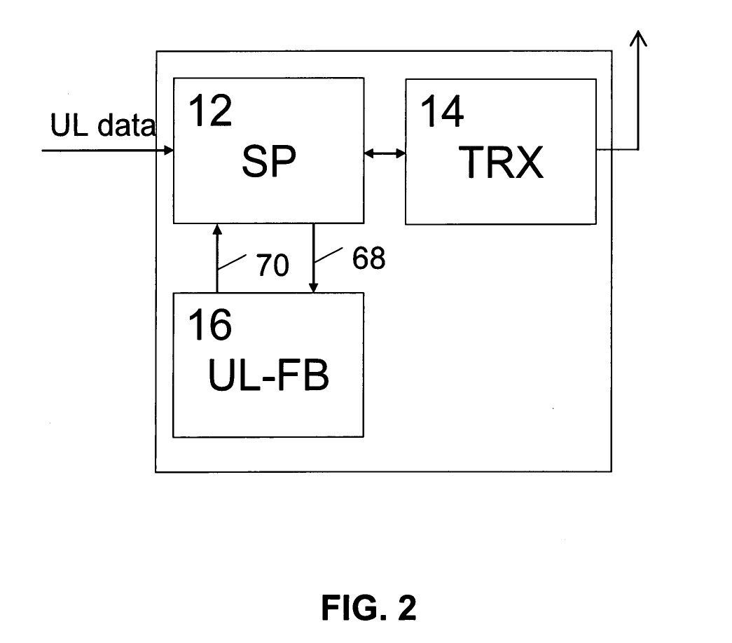

FIG. 2 shows a schematic block diagram of a transmit and receive unit which may be used in certain embodiments, such as the MS 10, which may be configured to support or implement an advanced feedback signaling with a mode indicator. Access to the radio access network may be provided by a transceiver unit 14 capable of receiving and transmitting RF signals via at least one antenna. As an alternative the transceiver unit 14 may comprise or may be replaced by separate transmitter and receiver units with separate transmission and receiving paths. As an example, in order to support SU-MIMO reception, the MS 10 might need to be capable of receiving RF signals via at least two antennas.

The transceiver unit 14 may be connected to a signal processing stage 12 which responsible for receiver-related processing, (e.g., demodulating, descrambling, decoding etc.) of received DL data, and for transmitter-related processing, (e.g., modulating, scrambling, coding etc.) of UL data to be transmitted. The signal processing stage 12 may additionally be configured to determine or extract a basic operation mode 68 received for example by a higher-layer signaling from a radio-connected BS, e.g. BS 20 of FIG. 1. This basic operation mode 68 may be supplied to an UL feedback circuit 16 which generates an UL feedback information 70 and a mode indicator 80 as described below in more detail. The UL feedback information 70 and the mode indicator 80 may be added, e.g. as a binary control word, to an UL stream transmitted via the UL transmission beam 50 towards the radio-connected BS.

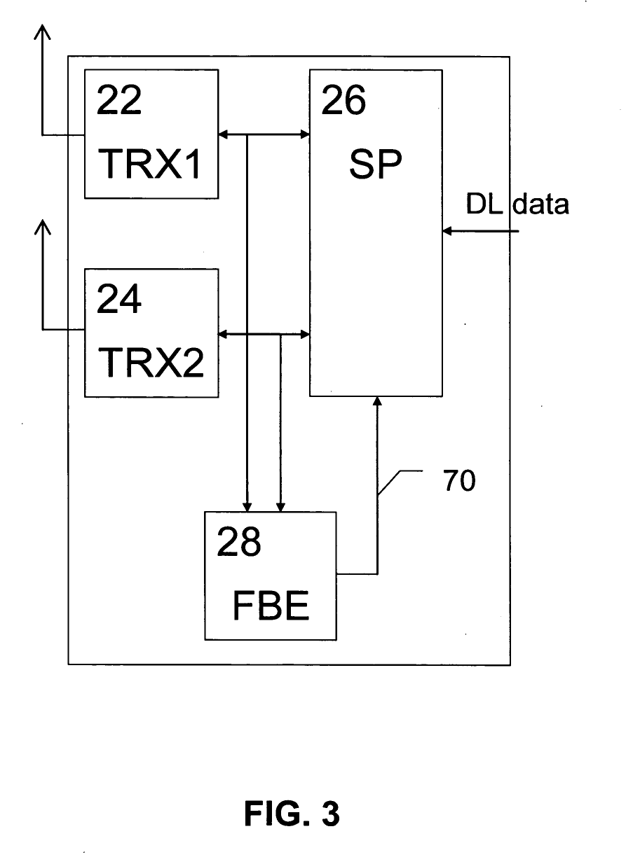

FIG. 3 shows a schematic block diagram of a base station device, e.g. the BS 20, according to certain embodiments, with two antennas for transmitting and receiving data. In the present example, both antennas are connected to respective transceiver units 22 and 24. Of course, both antennas can be connected to a single transceiver unit capable of processing two transmission and reception streams. Alternatively, both antennas may be pure Tx antennas, while at least one separate reception antenna may be provided for receiving an UL data stream with the feedback information 70 and the mode indicator 80. Furthermore, a feedback extraction unit 28 may be provided, to which the received UL data is supplied in order to extract or derive the feedback information 70 and mode indicator 80. The transceiver units 22 and 24 may further be connected to a signal processing stage 26 responsible for receiver-related processing, (e.g., demodulating, descrambling, decoding etc.) for received UL data, and for transmitter-related processing, (e.g., modulating, scrambling, coding, beamforming, user selection etc.) for DL data to be transmitted. The signal processing stage 26 may be controlled by the feedback information 70 and the mode indicator 80 supplied by the feedback extractor unit 28, so as to control multi-antenna transmission based on the feedback information which may be interpreted under consideration of the mode indicator 80.

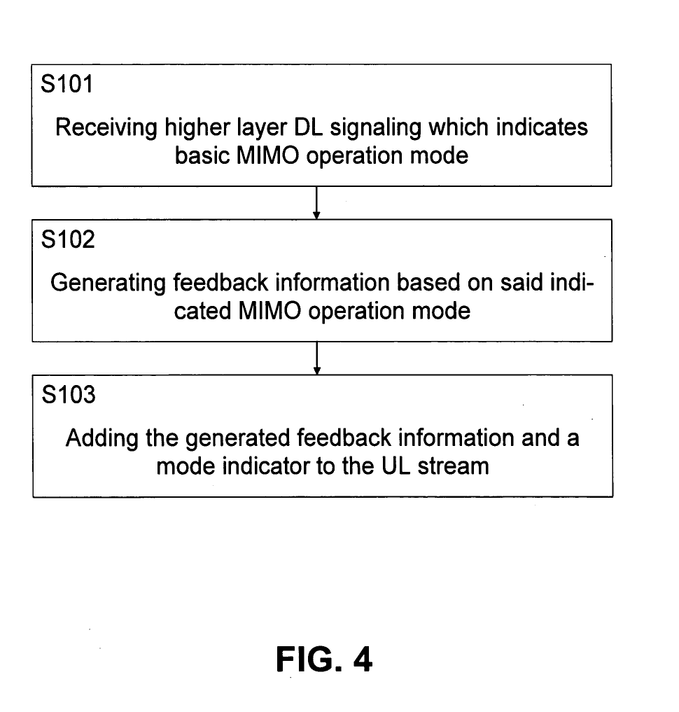

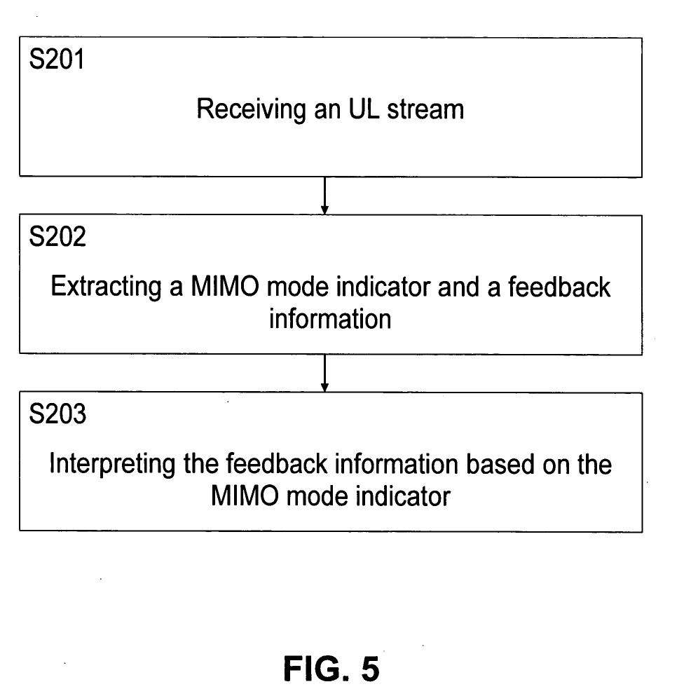

FIGS. 4 and 5 show flow diagrams of the basic processing steps at both radio communication ends of a MIMO transmission system with multiple transmission antennas according to an implementation example of an advanced feedback signaling according to certain embodiments.

In this example, the processing at the receiving end, e.g., at the MS 10, is shown in FIG. 4 and comprises a first step S101 of receiving a higher layer DL signaling in which the basic MIMO operating mode, e.g. SU-MIMO or MU-MIMO, is indicated. Then, the required feedback information 70 may be generated in step S102 based on the received or indicated basic MIMO operation mode. In step S103, the generated feedback information and the reported mode indicator 80, which has been set and may be used to signal the selected operation mode to be reported for multi-antenna DL transmission, are added to the UL transmission stream forwarded to the transmitting end of the MIMO system.

In this example, the processing at the transmitting end, e.g., at the BS 10, is shown in FIG. 5 and comprises a first step S201 of receiving an UL stream with the incorporated advanced feedback signaling. Then, the incorporated feedback information 70 and the added mode indicator 80 are extracted in step S202. Then, in step S203, the extracted feedback information 70 is interpreted at the transmitting end by referring to the extracted mode indicator 80. Thereby, the transmitting end may be capable of controlling multi-antenna transmission based on the interpreted feedback information 70.

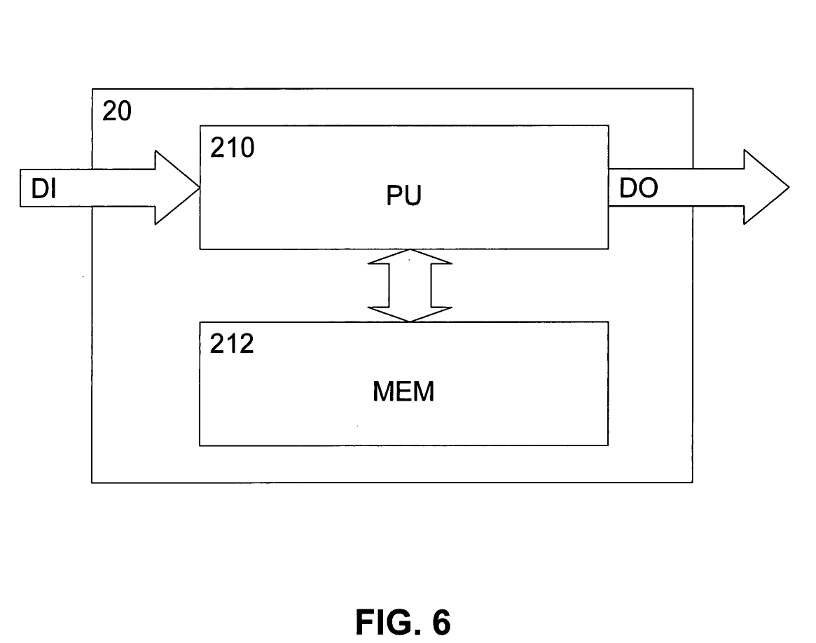

FIG. 6 shows a schematic block diagram of a software-based implementation of an advanced feedback transmission system according to certain embodiments. This example may include the transmitter shown in FIG. 3 and the receiver shown in FIG. 2, each with a processing unit 210, which may be any processor or computer device with a control unit which performs control based on software routines of a control program stored in a memory 212. Program code instructions may be fetched from the memory 212 and loaded to the control unit of the processing unit 210 in order to perform the processing steps of the above functionalities described in connection with the respective FIGS. 4 and 5 or with the respective blocks 12 and 16 of FIG. 2 or blocks 26 and 28 of FIG. 3. These processing steps may be performed on the basis of input data DI and may generate output data DO, wherein at the receiver end the input data DI may correspond to the received DL data and the output data DO may correspond to the feedback information 70 and mode indicator 80. On the other hand, at the transmitter side, the input data may correspond to the received UL data and the output data may correspond to control information required to control multi-antenna transmission.

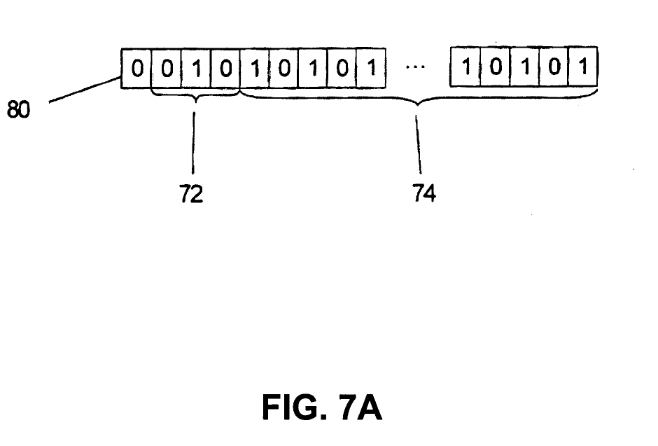

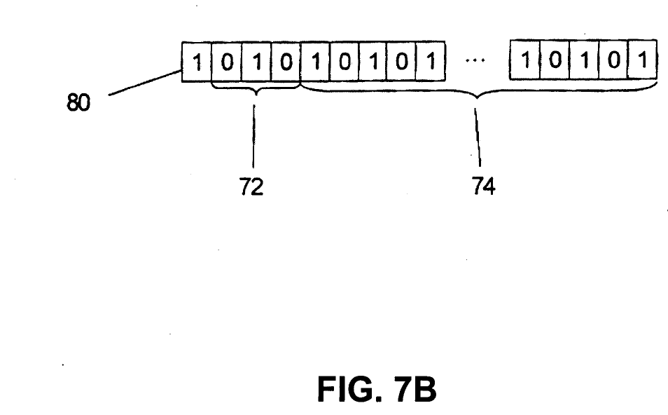

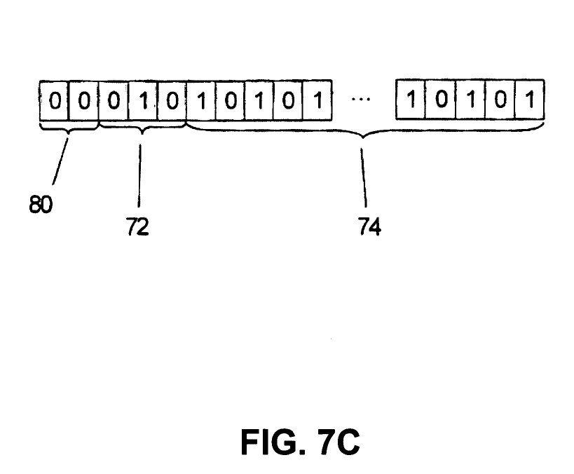

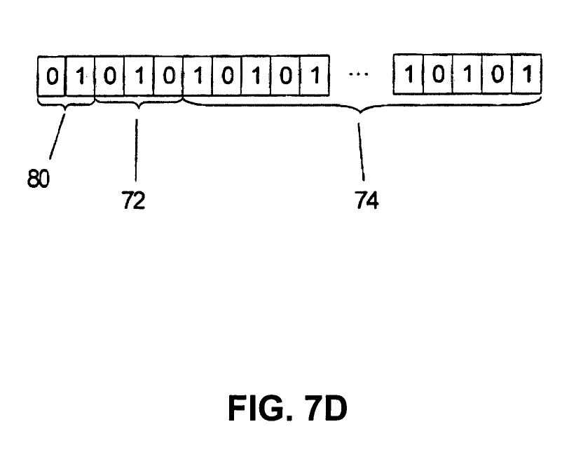

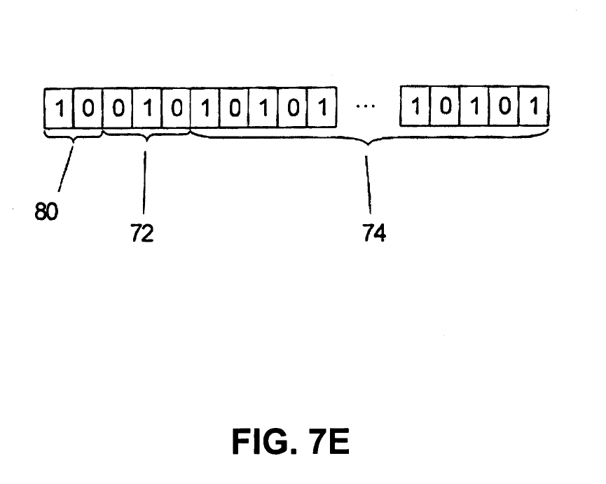

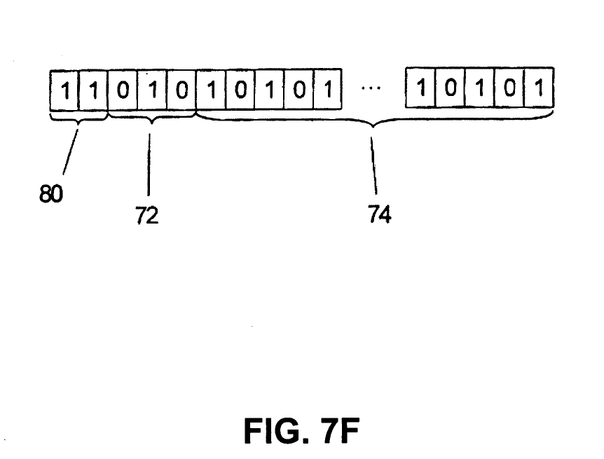

FIGS. 7A to 7F show various interpretation examples of or bit allocation schemes for the extracted feedback information for different operation modes, wherein the first bit(s) on the left side of the depicted binary control words may be used to indicate the mode indicator 80, and the following second portion 72 (3 bits) and third portion 74 may be interpreted based on the binary value(s) of the mode indicator 80.

In FIG. 7A, an exemplary feedback signaling structure for SU-MIMO with single stream transmission and spatial CQI/CSI feedback is illustrated. In this example, the feedback information 70 includes a “0”-bit as mode indicator 80, a 3-bit precoding/beamforming information (e.g. a non-frequency-selective codebook index) in the second portion 72 as well as a basic (e.g. frequency selective) CQI information for the AMC/LA and possible frequency domain packet scheduling in the third portion 74.

FIG. 7B shows an example of dual stream (e.g. multi-codeword transmission) with a “1”-bit mode indicator 80 that indicates PARC transmission, the basic (e.g. frequency selective) CQI information in the third portion 74 available for the first stream and a non-frequency selective 3-bit relative CQI in the second portion 72 for the second stream with respect to the first stream.

The above CQI examples may relate to spatial CQI. In addition thereto, a CQI in the frequency domain can be used, allowing frequency domain packet scheduling. Then, the CQI information in the third portion 74 can be used for the first transmission stream, which may be the same allocation as in case of SISO according to FIG. 7A. This is indicated by the larger bitfield in FIG. 7A to 7F for the third portion 74 allowing frequency selective CQI reporting e.g. for OFDM (Orthogonal Frequency Division Multiplexing) systems. Thus, the additional feedback information (in addition to the SISO case), may require four bits—namely the 1-bit mode indicator 80 as well as in the second portion 72 either the 3-bit relative CQI of FIG. 7B for the second stream for PARC or the 3-bit precoding/beamforming information of FIG. 7A for single stream beamforming. The same preceding might be used for all allocated resource blocks as well as the relative CQI allows AMC with respect to the first stream (e.g., when the same modulation and coding scheme is used for all allocated resource blocks).

In an exemplary modification of the embodiment, the feedback information may be divided into two parts. The type of one part of the feedback information might not depend on the transmission mode, whereas the other part of the feedback information may depend on the transmission mode. The part of the feedback information that does not depend on the transmission mode may be a bit field of a fixed length. It may be related for example to the channel quality of one data stream, possibly indicated in the frequency domain.

The part that depends on the transmission mode may be a bit field of fixed length, which may refer to different characteristics of the transmission for different modes. For example, in one mode, the bits in this bit field may refer to spatial preceding information, whereas in another mode, the bits may refer to relative CQI information.

In another exemplary modification of the embodiment, the part of the feedback information that does not depend on the transmission mode may be the only information that a scheduler needs to decide on the scheduling of users. The other bits of the feedback information may be needed to determine the actual transmission mode of the user. For example, the bits that do not depend on the mode may indicate the frequency selective sum CQI for a multi-stream transmission, and the CQI for a single stream for a precoded single-stream transmission. The bits depending on the mode selection may then determine the division of the sum CQI among the streams for a multi-stream transmission, and the precoding for a single-stream transmission.

In the following, an example for the use of the above four bits for multi-user MIMO DL transmission is described. In this example, MU-MIMO as the basic MIMO operation mode may have been signaled via higher layer DL signaling by the NodeB 20 to the MS 10.

For DL MU-MIMO with two Tx antennas, there might only be the possibility to transmit to a single user or two users. The precoding in case of MU-MIMO may use a unitary transmission matrix (e.g., where the transmission vectors for different users are orthogonal). In this example, a user who is in bad channel conditions (and therefore needs the full available Tx power in order to support the minimum modulation and coding scheme), or if the interference produced by MU transmission is so high that the expected throughput would be e.g. less than ½ compared to the case of SU beamforming transmission, the receiver at the MS 10 may choose to set the mode indicator 80 to “0” in order to report for single-stream SU beamforming, so that the calculated and reported CQI in the third part 74 may assume full transmission power as well as no intracell interference due to MU transmission in addition to the precoding vector. The bit allocation of the codeword may then correspond to FIG. 7A (mode indicator set to “0”), where the 3-bit beamforming/precoding information may be allocated to the second portion 72 as well as the estimated CQI assuming single user transmission in the third section 74.

Alternatively, in this example, when the MU transmission is reasonable from the user's point of view (i.e., when the minimum modulation and coding scheme can be supported, and interference power results in, for example, more then half of the throughput compared to SU transmission for this user), the receiver at the MS 10 may choose to set the mode indicator 80 to “1” in order to report for MU transmission, so that the reported CQI may assume half the available TX power for its transmission as well as intercell interference from a multi-user transmission with an orthogonal transmission weight in addition to the preferred preceding vector (3 bits). Here, the bit allocation of the codeword may correspond to FIG. 7B (mode indicator set to “1”), where the 3-bit beamforming/precoding information is allocated to the second portion 72 as well as the estimated CQI assuming multi-user transmission to the third section 74. The difference between the reporting in the MU-MIMO mode of single user transmission described in the previous paragraph and multi-user transmission, may be the mode indicator 80 (“0” or “1” respectively) and how the CQI information in 74 is calculated at the MS 10 and may be interpreted.

The difference between these two reporting modes can be indicated by the 1-bit mode indicator 80 which may indicate if the report is valid for MU transmission or SU transmission.

In this example, the BS 20 may define either SU or MU MIMO operation modes by higher layer signaling. In other examples where this might not be the case (and the MS 10 can define the best operation mode taking its current channel and signal-to-noise ratio (SNR) operation point into account), more feedback information (at least one bit) may be needed.

FIGS. 7C to 7F show exemplary feedback signaling structures or bit allocation schemes, where (the first) two bits may be allocated to or reserved for the mode indicator 80.

According to FIG. 7C, the bit combination “00” of the mode indicator 80 signals single-user and single-stream transmission, where the second portion 72 may be interpreted as (non-frequency-dependent) precoding/beamforming codebook index and the third portion 74 may be interpreted as general (e.g. frequency-selective) CQI information.

According to FIG. 7D, the bit combination “01” of the mode indicator 80 may denote single-user multi-stream transmission, where the second portion 72 may be interpreted as a (non-frequency-selective) relative CQI information for the second transmission stream, while the third portion 74 may be interpreted as a (e.g. frequency-selective) CQI information for the first transmission stream.

According to FIG. 7E, the bit combination “10” of the mode indicator 80 may denote multi-user transmission, where the second portion 72 may be interpreted as a (non-frequency-selective) precoding/beamforming codebook index, while the third portion 74 may be interpreted as a frequency-selective CQI information assuming SDMA to two users.

According to FIG. 7F, the remaining bit combination “11” of the mode indicator 80 can be used by the receiver at the MS 10 to indicate its desire to utilize diversity transmission methods or other open-loop single-user transmission schemes. Then, the three bits of the second portion 72 might not be allocated or utilized for something specifying the diversity or other open-loop transmission scheme further (e.g. the selection of the delay value for cyclic delay diversity for OFDM systems, the number of streams supported for OL SU-MIMO transmission using matrix modulations).

It should be noted that the above bit allocation and interpretation examples are not limiting and can be extended or amended in various ways. The position, interpretation and bit number of the second and third portions 72, 74 as well as the mode indicator 80 may be changed based on the requirements of other implementations. As an example, in case of four Tx antennas, the interpretation of the feedback information 70 may change depending on the number of transmission streams etc. In an exemplary case of multi-codeword single-user MIMO with up to 4 streams, the strongest stream and also the relative CQI (3 bit) in the negative direction from the strongest stream could be signaled by the feedback information. The following table contains possible information contents of the feedback information 70 and the corresponding total numbers of bits in dependence on the number of transmission streams:

| Number of | Ordering | Beam | | Total for x |
|---|---|---|---|---|
| streams | information | selection | Relative CQI | streams |
| 1 | 0 | 32 | 0 | 4 * 8 |
| 2 | 2 | 6 | 8 (3 bit) | 12 * 8 |
| 3 | 6 | 4 | 8 (3 bit) | 24 * 8 |
| 4 | 24 | 0 | 8 | 24 * 8 |
| In total | | | | 64 * 8 = 9 bit |

As shown in the above table, in order of stream strength, there may be 24 possibilities for 4 streams (i.e., 4!=4*3*2*1=24), 6 (i.e., 3!) for 3 streams, and 2 for 1 stream. For a single stream no ordering may be needed. Furthermore, the relative CQI may be assumed to have a length of three bits. The relative CQI can be used in a sense that the CQI of the second strongest stream may be approximated as CQI+relative CQI, the one for the third strongest stream CQI+2*relative CQI and so on. In this example, up to nine bits of information may be allocated to the feedback information depending on the number of streams. Other set-ups for four Tx antennas are of course possible as well.

It is further noted that the functionalities of blocks 12 and 16 of FIG. 2 as well as blocks 26 and 28 of FIG. 3 can be implemented as discrete hardware or signal processing units, or as software routines or programs controlling a processor or computer device to perform the processing steps of at least some of the above described functionalities.

Hence, a flexible and rather straightforward feedback signaling option is described herein, which allows for defining at the receiving end the kind of information should may fed back and in which format, in order to be able to use the same amount of total feedback information independent of the operation mode (e.g., single stream transmission vs. SU-MIMO with two streams vs. multi-user MIMO).

As described above, certain embodiments (e.g., including methods, a system, a transmitter apparatus, a receiver apparatus, and computer program products) may allow for enhanced feedback in a multi-antenna transmission system, wherein an operation mode of a multi-antenna transmission end may be determined at a reception end of a connection, and a feedback information and a mode indicator may be generated based on the determined operation mode and transmitted to the multi-antenna transmission end where the feedback information may be interpreted based on the mode indicator. Thereby, different operation modes can be supported by the same amount of total feedback information and might not require any change in signaling setup.

Conventional methods for compressing frequency domain CQI reporting may be used. For example, the CQI report of a user may be built up based on multiple feedback reports, with the granularity increasing with the number of reports.

It is to be noted that the present invention is not restricted to the embodiments described above, but can be implemented in different network environments involving multi-antenna transmission controlled by feedback signaling. Different signaling format or means may be used for feeding back the mode indicator and the feedback information.

1. A method comprising:
determining at a reception end of a connection an operation mode of a multi-antenna transmission end of said connection;
generating feedback information and a mode indicator based on said determined operation mode;
adding said feedback information together with said mode indicator to a data stream; and
transmitting from said reception end via said connection to said multi-antenna transmission end.

2. The method of claim 1, wherein said determination is performed based on a signaling received from said multi-antenna transmission end.

3. The method of claim 2, wherein said signaling is a signaling of a protocol layer higher than the protocol layer of said data stream.

4. The method of claim 1, further comprising:
selecting as said operation mode one of a single-user single-stream transmission mode, a single-user multi-stream transmission mode, a multi-user transmission mode, a diversity transmission mode, and an open loop single-user transmission Mode.

5. The method of claim 1, wherein said feedback information is divided into two parts, wherein one part of said feedback information does not depend on said operation mode and the other part of said feedback information depends on said operation mode.

6. The method of claim 5, wherein the part of said feedback information that does not depend on said operation mode is a bit field of a fixed length.

7. The method of claim 5, wherein the part of said feedback information that depends on said operation mode is a bit field of fixed length corresponding to different transmission characteristics of different operation modes.

8. The method of claim 7, wherein the bits in said bit field corresponding to the transmission characteristics for one of said different operation modes contains one of spatial preceding information and relative channel quality information.

9. The method of claim 8, wherein said part of said feedback information that does not depend on said operation mode corresponds to a frequency selective sum of channel quality information for a multi-stream transmission and channel quality information for a single stream of a precoded single-stream transmission, and wherein said part of said feedback information that depends on said operation mode corresponds to a division of said sum channel quality information among streams for a multi-stream transmission and precoding for a single-stream transmission.

10. The method of claim 1, further comprising indicating by said feedback information at least one of a channel quality information, a channel state information, a preceding information, and diversity transmission mode information.

11. The method of claim 1, further comprising using said mode indicator to define allocation and interpretation of individual bits of said feedback information.

12. The method of claim 1, wherein said mode indicator is a one-bit mode indicator or a two-bit mode indicator, and wherein said multi-antenna transmission end comprises two transmission antennas.

13. The method of claim 1, wherein said mode indicator is one of a two-bit mode indicator and a three-bit mode indicator, and wherein said multi-antenna transmission end comprises four transmission antennas.

14. A method comprising:
receiving at a multi-antenna transmission end a data stream which comprises feedback information;
extracting from said received data stream said feedback information and a mode indicator which indicates an operation mode of said multi-antenna transmission end;
interpreting said feedback information based on said mode indicator; and
controlling multi-antenna transmission based on said interpreted feedback information.

15. The method of claim 14, wherein said controlling multi-antenna transmission comprises at least one of scheduling, preceding, beamforming, multiplexing and link adaptation.

16. The method of claim 15, further comprising selecting as said operation mode one of a single-stream transmission mode, a single-user transmission mode, a multi-user transmission mode, a diversity transmission mode, and an open loop single-user transmission mode.

17. The method of claim 16, further comprising determining from said mode indicator additional information corresponding to said operation mode.

18. The method of claim 14, further comprising deriving from said feedback information at least one of a channel quality information, a channel state information and a precoding information.

19. An electronic apparatus comprising:
a processor controlling at least some operations of the electronic apparatus;
a memory storing computer executable instructions that, when executed by the processor, cause the electronic apparatus to perform a method of controlling multi-antenna transmission, the method comprising:
receiving a data stream comprising feedback information;
extracting from said received data stream said feedback information and a mode indicator corresponding to an operation mode of a selected multi-antenna transmission scheme;
interpreting said feedback information based on said mode indicator; and
controlling multi-antenna transmission in response to said feedback information.

20. The apparatus of claim 19, wherein said controlling comprises configuring the apparatus to control at least one of scheduling, precoding, beamforming, multiplexing, and link adaptation for said multi-antenna transmission.

21. The apparatus of claim 19, wherein said interpreting comprises configuring the apparatus to derive from said feedback information one of a single-stream transmission mode, a single-user transmission mode, a multi-user transmission mode, a diversity transmission mode, and an open loop single-user transmission mode.

22. The apparatus of claim 21, wherein said interpreting comprises configuring the apparatus to determine from said mode indicator additional information corresponding to said operation mode.

23. The apparatus of claim 19, wherein said feedback information comprises at least one of a channel quality information, a channel state information, and a precoding information.

24. The apparatus of claim 19, wherein said apparatus comprises two transmission antennas and said mode indicator is a one-bit or a two-bit mode indicator.

25. The apparatus of claim 19, wherein said apparatus comprises four transmission antennas and said mode indicator is one of a two-bit mode indicator and a three-bit mode indicator.

26. An electronic apparatus comprising:
a processor controlling at least some operations of the electronic apparatus;
a memory storing computer executable instructions that, when executed by the processor, cause the electronic apparatus to perform a method of transmitting to a multi-antenna transmission end, the method comprising:
determining an operation mode of a multi-antenna transmission end;
generating feedback information and a mode indicator based on said determined operation mode;
adding said feedback information together with said mode indicator to a data stream; and
transmitting said data stream to said multi-antenna transmission end.

27. The apparatus of claim 26, wherein said determining comprises configuring the apparatus to determine said operation mode based on a signaling received from said multi-antenna transmission end.

28. The apparatus of claim 27, wherein said signaling is a signaling of a protocol layer higher than the protocol layer of said data stream.

29. The apparatus of claim 26, wherein said determining comprises configuring the apparatus to determine said operation mode as one of a single-stream transmission mode, a single-user transmission mode, a multi-user transmission mode, a diversity transmission mode, or an open loop single-user transmission mode.

30. The apparatus of claim 29, wherein said generating comprises configuring the apparatus to generate said mode indicator to indicate additional information corresponding to said operation mode.

31. The apparatus of claim 26, wherein said generating comprises configuring the apparatus to indicate by said feedback information at least one of a channel quality information, a channel state information and a precoding information.

32. The apparatus of claim 26, wherein said generating comprises configuring the apparatus to generate a one-bit mode indicator or a two-bit mode indicator for a multi-antenna transmission end with two transmission antennas.

33. The apparatus of claim 26, wherein said generating comprises configuring the apparatus to generate one of a two-bit mode indicator and a three-bit mode indicator for a multi-antenna transmission end with four transmission antennas.

34. The apparatus of claim 19, wherein said apparatus comprises a base station device.

35. The apparatus of claim 26, wherein said apparatus comprises a mobile station.
